(19) United States
(12) Patent Application Publication
(10) Pub. No.: US 2010/0208370 A1
(43) Pub. Date: Aug. 19, 2010

(54) CAMERA LENS ASSEMBLY

(76) Inventor: Ying-Kuo Chang, Taichung County (TW)

Correspondence Address: Ying-Kuo Chang, Chung - Ho Box 8-24, Taipei, 235, TW

(21) Appl. No.: 12/389,363

(22) Filed: Feb. 19, 2009

(51) Int. Cl. G02B 7/02

(52) U.S. Cl. 359/819

(57) ABSTRACT

A camera lens assembly mainly includes the following components. A lens cylinder is installed in a light sensing set. The lens cylinder has at least one lens. A light sensing set includes a frame arranged on a circuit substrate. The frame serves to connect the lens cylinder. The circuit substrate is soldered to a main frame through soldering points. A digital light sensing element is arranged on the circuit substrate and is connected to the circuit substrate so as to receive the light projected from the lens. Through the components mentioned above, the lens cylinder and the light sensing set are assembled together as one simple electronic unit. Thus, the precision of the unit will not be influenced by the further simple installation and the cost of the manufacturing process can be lowered.

### FIELD OF THE PRESENT INVENTION

The present invention relates to camera lens, and in particular to a camera lens assembly which can be applied to a camera lens with small/slim-sized non-spherical glass lens, the component is highly heat-proof while being processed.

### DESCRIPTION OF THE PRIOR ART

As the development of technique, the camera lens is designed smaller and lighter. The precise focus distance and the positioning of the optic lens inside the structure are also highly concerned as well as the delicate outer appearance.

The optic lens of a prior lens cylinder is usually a spherical glass lens. Because of the thickness of the spherical glass lens can not be slimed, a high and large lens cylinder is used so that it is not suitable for modern design of small and slim style. In order to slim the size, a plastic lens is used in the lens cylinder. The plastic lens will not be completely functional after a high temperature solder pot process changing the focus distance of the lens because of the plastic lens can not sustain a high temperature. Thus, yield of the product will be lowered.

Therefore, to solve the disadvantage is the main object of the inventor of the present invention.

### SUMMARY OF THE PRESENT INVENTION

Accordingly, the primary object of the present invention is to simplify the whole manufacturing process by integrating a lens cylinder and a light sensing set in one unit. Through the high temperature proof ability of a non-spherical glass lens, the combined lens cylinder and the light sensing set is fixed to a circuit substrate by a solder pot or lead-free process. The circuit substrate is plugged to a main frame by a pluggable pin, after that, the solder pot process is not a necessary process.

To achieve above object, the present invention provides a A camera lens assembly comprising: a lens cylinder being fixed in a light sensing set and having at least one lens inside thereof; a light sensing set including a frame arranged on a circuit substrate; the frame serving to connect the lens cylinder; the circuit substrate being soldered to a main frame through soldering points formed on the circuit substrate; a digital light sensing element being arranged on the circuit substrate and being connected to the circuit substrate so as to receive the light projected from the lens; through the assembly of the components mentioned above, the lens cylinder and the light sensing set being assembled together as one unit; the precision of the unit not being influenced by the further simple installation and the cost of the manufacturing process being lowered.

The lens is a non-spherical glass lens. At least one lens is installed in the cylinder. The main frame is one of a cell phone and camera which has a connector for connecting. The connector of the light sensing set is a pluggable pin; the light sensing set is plugged to the main frame through the pluggable pin. An inclined protrusion is formed at an inner side of the lens cylinder; the inclined protrusion has light sheltering effect when the lens is installed to the lens cylinder by the side of the inclined protrusion. A connector is formed to a lateral side of the circuit substrate of the light sensing set so as to connect to the main frame through the connector.

### BRIEF DESCRIPTION OF THE DRAWINGS

FIG. 1 is a perspective view showing the structure of the present invention.

FIG. 2 is a perspective view showing a lens cylinder of the present invention.

FIG. 3 is a perspective view showing another lens cylinder embodiment of the present invention.

FIG. 4 is a manufacturing diagram of the present invention.

FIG. 5 is a schematic view showing another embodiment of the present invention.

FIG. 6 is a comparing sheet of the present invention and prior lens structures.

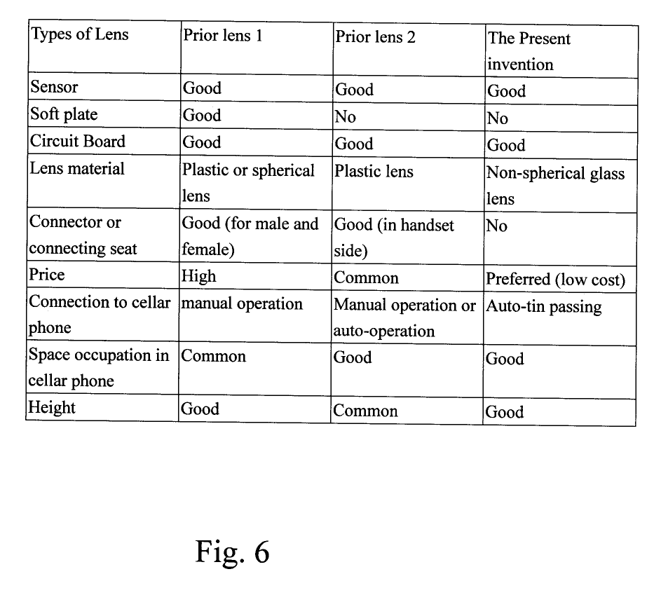

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

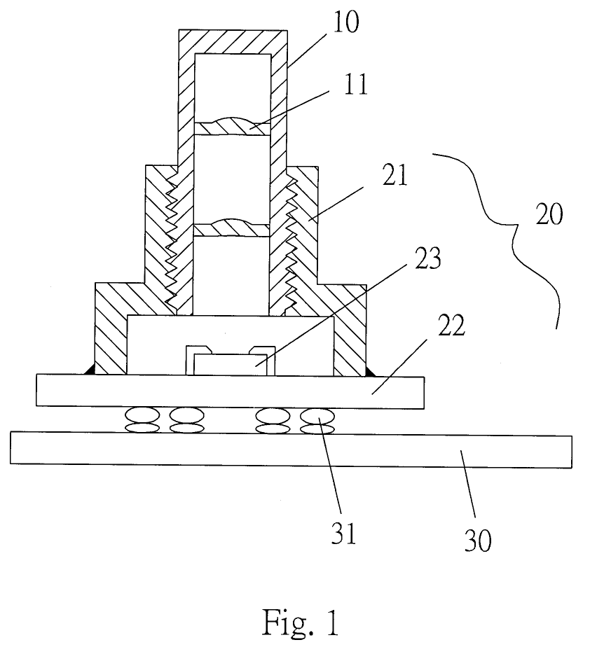

With reference to FIG. 1, a camera lens assembly according to the present invention is illustrated. The main components will be described in the following.

A lens cylinder 10 is installed in a light sensing set 20. The lens cylinder 10 has at least one lens 11 in which the lens 11 is a non-spherical glass lens.

The light sensing set 20 includes a frame 21 arranged on a circuit substrate 22. The frame 21 serves to connect the lens cylinder 10. The circuit substrate 22 is soldered to a main frame 30 through soldering points 31 formed on the circuit substrate 22. A digital light sensing element 23 is arranged on the circuit substrate 22 and is connected to the circuit substrate 22 so as to receive the light projected from the lens 11.

Through the components mentioned above, the lens cylinder 10 and the light sensing set 20 are assembled together as one simple unit. The precision of the unit will not be influenced by the further simple installation and the cost of the manufacturing process can be lowered.

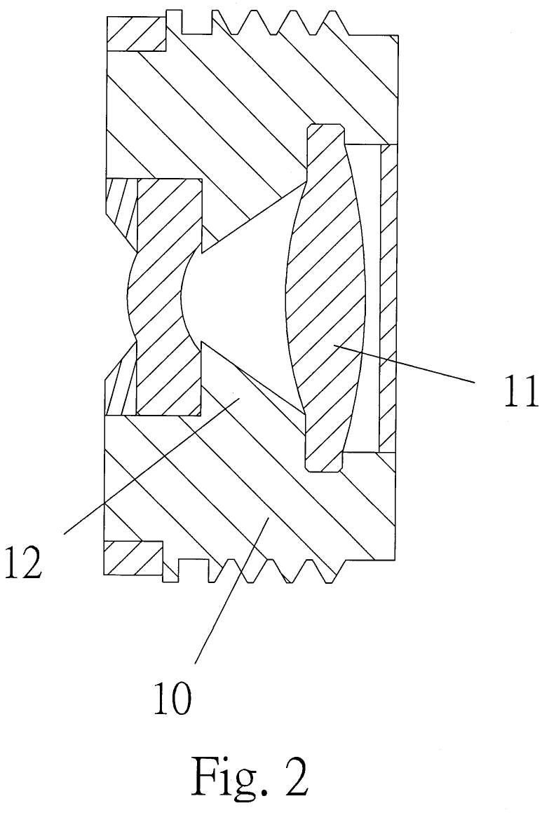

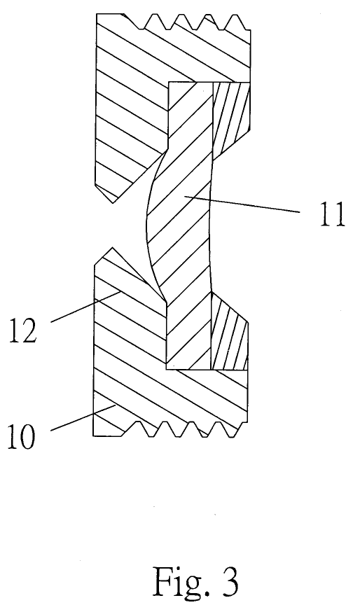

Referring to FIG. 2, a schematic view of the lens cylinder according to the present invention is illustrated. An inclined protrusion 12 is formed at an inner side of the lens cylinder 10. The inclined protrusion 12 has light sheltering effect when the lens 11 is installed to the lens cylinder 10 by the side of the protrusion 12. With reference to FIG. 3, a schematic view of another lens cylinder according to the present invention is illustrated. The lens cylinder 10 is assembled with the lens 11 and can be screwed to the frame 21.

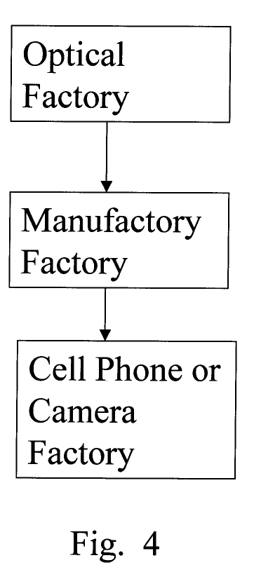

Referring to FIG. 4, a manufacturing diagram of the present invention is illustrated. Firstly, the lens 11 is installed to the lens cylinder 10 in an optic factory, wherein at least one lens is installed to the cylinder 10 and the lens 11 is a non-spherical glass lens. In a manufacture factory, the lens cylinder 10 installed with the lens 11 will be further arranged to a light sensing set 20 which includes a frame 21 and a circuit substrate 22. A digital light sensing element 23 is arranged on the circuit substrate 22 so as to receive the light projected from the lens 11. At last, the completed improved lens structure can be provided to a cell phone factory or a camera factory for assembly.

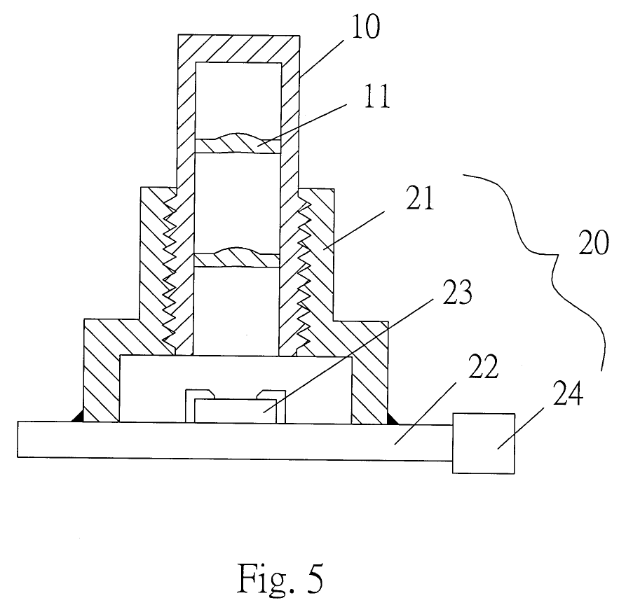

Referring to FIG. 5, a schematic view of another embodiment according to the present invention is illustrated. A connector is formed to a lateral side of the circuit substrate of the light sensing set so as to connect to the main frame through the connector.

With reference to a comparing sheet of the present invention and prior lens structures, the improved lens structure of the present invention can be soldered to a main frame by an SMT (Surface Mount Technology) machine in the process of manufacturing. The prior lens structure needs a Flexible Printed Circuitry (FPC) board and a connector so that a handiwork is needed in the process of manufacturing. The prior lens structure 2 is soldered to a main frame through a connector and further combined with a lens. In comparison, the installation process of the present invention to a main frame is easier and the occupied space is smaller.

To reveal the improvement and the practicability of the present invention, the effects and features are described in the following.

1. The present invention can be applied to a camera lens, and in particular to the camera lens of a cell phone and a camera.

2. The lens cylinder and the light sensing unit are assembled as one single component so that the precision of the component will not be influenced by the further simple installation. The process of manufacturing can be shortened and the cost of the process can be lowered as well.

3. The present invention can be applied to a camera lens with small/slim size non-spherical glass lens, the component is highly heat-proof while being processed.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A camera lens assembly comprising:
a lens cylinder being fixed in a light sensing set and having at least one lens inside thereof;
a light sensing set including a frame arranged on a circuit substrate; the frame serving to connect the lens cylinder; the circuit substrate being soldered to a main frame through soldering points formed on the circuit substrate; a digital light sensing element being arranged on the circuit substrate and being connected to the circuit substrate so as to receive the light projected from the lens;
through the assembly of the components mentioned above, the lens cylinder and the light sensing set being assembled together as one unit; the precision of the unit not being influenced by the further simple installation and the cost of the manufacturing process being lowered.

2. The camera lens assembly as claimed in claim 1, wherein the lens is a non-spherical glass lens.

3. The camera lens assembly as claimed in claim 1, wherein at least one lens is installed in the cylinder.

4. The camera lens assembly as claimed in claim 1, wherein the main frame is one of a cell phone and camera which has a connector for connecting.

5. The camera lens assembly as claimed in claim 1, wherein the connector of the light sensing set is a pluggable pin; the light sensing set is plugged to the main frame through the pluggable pin.

6. The camera lens assembly as claimed in claim 1, wherein an inclined protrusion is formed at an inner side of the lens cylinder; the inclined protrusion has light sheltering effect when the lens is installed to the lens cylinder by the side of the inclined protrusion.

7. The camera lens assembly as claimed in claim 1, wherein a connector is formed to a lateral side of the circuit substrate of the light sensing set so as to connect to the main frame through the connector.
